(19) United States
(12) Patent Application Publication
(10) Pub. No.: US 2017/0021530 A1
(43) Pub. Date: Jan. 26, 2017

(54) GEMSTONE PROCESSING

(71) Applicant: SAHAJANAND TECHNOLOGIES PRIVATE LIMITED, Surat, Gujarat (IN)

(72) Inventors: Rahul Mahendrakumar GAYWALA, Surat, Gujarat (IN); Munjalkumar Dhirajlal GAJJAR, Surat, Gujarat (IN); Chetan Fulchandbhai PATEL, Surat, Gujarat (IN)

(73) Assignee: SAHAJANAND TECHNOLOGIES PRIVATE LIMITED, Surat, Gujarat (IN)

(21) Appl. No.: 15/039,054

(22) PCT Filed: Jul. 22, 2015
(86) PCT No.: PCT/IB2015/055538

§ 371 Date: May 25, 2016

(30) Foreign Application Priority Data
Jul. 22, 2014 (IN) 2372/MUM/2014

(51) Int. Cl. B28D 5/00; G01N 21/87

(52) U.S. Cl. CPC B28D 5/0064; G01N 21/87; G01N 2201/06113

(57) ABSTRACT

Systems and methods for gemstone processing are described herein. According to an embodiment, a gemstone processing system includes a visualization system (100) for capturing stresses in a rough gemstone (104). The visualization system (100) can include an image capturing device (102), a gemstone stage (106) being rotatable with respect to the image capturing device (102), and one or more light sources (110, 112) to illuminate the rough gemstone (104) on the gemstone stage (106).

### TECHNICAL FIELD

The present subject matter relates, in general, to gemstone technology and, particularly but not exclusively, to gemstone processing.

### BACKGROUND

Gemstones are naturally occurring deposits of minerals and can include, for example, diamonds, quartz, opals, sapphires, rubies, emeralds, and topaz. Since the gemstones rare, they are highly valued for use, say in ornamentation and jewellery. The value of these gemstones results from their color, luster, and the manner in which they transmit, refract or reflect rays of light. For the enhancement of such properties, rough gemstones are processed, for instance, put through cutting, faceting, shaping, and polishing.

Further, in some regions of the body of the gemstone certain structural imperfections, such as cracks, cleavages, knots, small included crystals of different orientation with respect to the rest of the stone, or other internal physical defects, may be present. In addition, few other imperfections, such as stresses, points of stress concentration, or points of weakness, are present in the body of the gemstone. Accordingly, if the gemstone is cut or sawed in such a region, the gemstone may break incurring considerable amount of monetary loss. Therefore, during planning phase in which the processing of the gemstone is planned, it is relevant to detect presence of structural imperfections in the gemstone. Conventionally, the imperfections in the rough gemstone are detected by a naked eye or using a microscope.

### BRIEF DESCRIPTION OF DRAWINGS

The detailed description is described with reference to the accompanying figures. In the figures, the left-most digit(s) of a reference number identifies the FIGURE in which the reference number first appears. The same numbers are used throughout the drawings to reference like features and components.

FIG. 1 illustrates a schematic of a gemstone processing system, in accordance with an embodiment of the present subject matter.

### DETAILED DESCRIPTION

The present subject matter relates to methods and systems for gemstone processing, in accordance with an aspect of the present subject matter.

A gemstone may include structural imperfections, which may cause damage to the gemstone while processing of the gemstone and may cause wastage of precious gemstones. Such imperfections can include, for example, cracks, cleavages, knots, small included crystals of different orientation with respect to the rest of the stone, or other internal physical defects in some regions of the body. Usually, presence of structural imperfections within the gemstone is identified during planning phase in which the processing of the gemstone is planned. However, certain other imperfections, such as stresses concentrated at a point in the gemstone, may not be identifiable during the planning stage and may lead to damage to the gemstone during the processing stage.

Conventionally, for detecting such imperfections, such as stresses, in the rough gemstone, the gemstone is examined with a naked eye or under a microscope. However, such imperfections are usually more difficult to detect using manual inspection procedures, say owing to general lack of clarity in the rough stone. For example, it may be difficult to differentiate a structural imperfection, say stresses, under the surface of the gemstone from superficial damages on the raw gemstone. Such inspection of the gemstone may be inaccurate and may not enable prevention of wastage of the gemstones.

In addition, since the conventional procedure of detecting the imperfections, such as stresses, in the gemstone is completely manual, it does not facilitate in learning and training to enable other users to acquire the skill. Further, such convention procedures do not record the images of the gemstone, the manufacturers cannot review the gemstone planning decisions or back analyse the gemstone processing plan in case of gemstone breakage, and therefore, the analysis of the gemstone may not be reusable for reducing gemstone breakage.

The present subject matter relates to a gemstone processing system and a method for processing a gemstone, in accordance with an aspect of the present subject matter. The gemstone processing system, according to the present subject matter, provides for a pre-planning step in which stresses, such as localized or concentrated stresses, located in a rough gemstone are identified with substantial accuracy. In said example, the visualization system can identify the stresses in order to determine a strength of the gemstone. Accordingly, in the planning phase, various operations to be performed on the rough gemstone can be charted in accordance with the identified stresses. As will be understood, the rough gemstone can be the gemstone in the natural, non-processed condition.

In accordance with an implementation of the present subject matter, the gemstone processing system can include a visualization system having an image capturing device, a gemstone stage being rotatable with respect to the image capturing device and having a holder for mounting the gemstone, and one or more light sources to illuminate the gemstone on the gemstone stage. The gemstone stage can be coupled to an actuator controlled by a processing unit for effecting a rotational movement of the gemstone stage about a central axis, say of a shaft on which the gemstone stage is mounted. In an example, the visualization system can include two light sources—namely a first light source and a second light source. In an example, the first light source can be a back light source and the second light source can be a top light source. As the names suggest, the back light source is positioned behind the gemstone stage with respect to the image capturing device. In one case, the back light source and the camera can be positioned as facing each other, with the gemstone stage in between the two. The top light, on the other hand, can be positioned in-line with the central rotational axis of the gemstone stage.

During operation, as the gemstone stage rotates, rotating the rough gemstone along with, radiations are persistently incident on the rotating rough gemstone from the light source. In response to the passage of radiations through the rough gemstone, an optical pattern, say a rainbow pattern, is generated which is captured by the camera and stored. According to an aspect, the optical pattern is temporally captured along with the rotation of the rough gemstone, and stored. In other words, the optical pattern is captured along with its variation with time.

In addition, in an implementation, the visualization system can include a plurality of optical filters for filtering the radiations being exchanged during operation of the system. For example, the visualization system can include two optical filters positioned between the image capturing device, the back light source, and the gemstone stage. For instance, a first optical filter can be positioned between the back light source and the gemstone stage and a second optical filter can be positioned between the image capturing device and the gemstone stage.

Further, the visualization system can include a laser for measuring the rough gemstone and generating a graphical 3-dimensional view of the rough gemstone based on the measurement by the laser and the temporal images of the pattern formed by the rough gemstone captured by the image capturing device. In an implementation, the visualization system can associate a unique ID with the 3-dimensional image and store the same. Therefore, the laser can augment the operation of the visualization system and can facilitate in the planning phase of gemstone processing. For example, the visualization system can provide the generated 3-dimensional view of the rough gemstone and provide the same to a planning unit of the gemstone processing system.

In an implementation, the planning unit can include another set of gemstone stage and an image capturing device which can temporally capture frames, say as images or video, of the gemstone. In said implementation, the planning unit can use the temporal images of the pattern formed by the rough gemstone, the graphical 3-dimensional view, the rough gemstone, and the captured frames of the rough gemstone, for analysis. Based on the analysis of the temporal images, the 3-dimensional graphical view, and the captured frames, the planning unit can generate different plans for cutting the rough diamond without breakage. A user of the system can select one of the plans which can be physically marked on the rough gemstone and the rough gemstone is further processed, say cut and finished, based on the selected plan, say in a gemstone cutting and finishing system. In addition, the planning unit can provide the temporally captured images of the rough gemstone to the user which can be used in analysis to reduce breakage in later procedures, such as cutting. Further, the captured images can be used to analyze the gemstone in case there is a breakage even after planning.

The gemstone processing system, in accordance with the present subject matter, is easy to use and user friendly in handling and may not require considerable training of the user. Therefore, even a low skilled user can operate the gemstone processing system. In addition, the gemstone processing system avoids breakage of rough gemstone and facilitates in optimization of the cutting and finishing of the rough gemstone providing high yield of finished gemstone and prevents substantial amount of wastage of the rough gemstone. In addition, the evaluation of stresses in the rough gemstone can achieved at the planning level and corrective steps, if needed, can be taken. The gemstone processing system is flexible and scalable. In addition, since the gemstone processing system employs optics for identifying the stresses, the system is substantially accurate in detecting the stresses.

These and other advantages of the present subject matter would be described in greater detail in conjunction with the following figures. While aspects of described the gemstone processing system and method for gemstone processing can be implemented in any number of different configurations, the embodiments are described in the context of the following device(s).

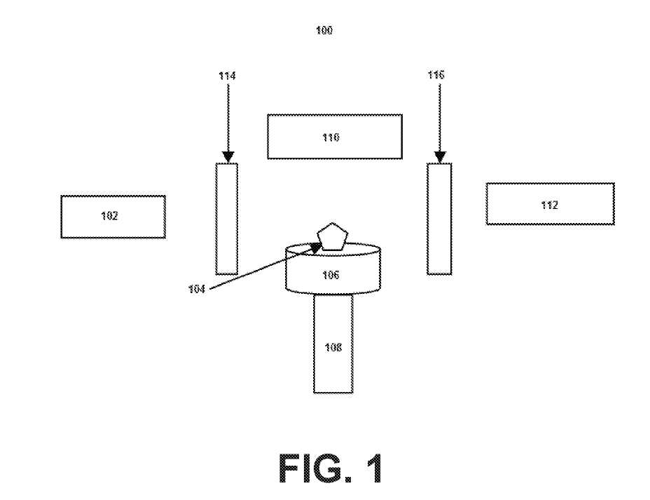

FIG. 1 illustrates a schematic of a gemstone processing system, in accordance with an embodiment of the present subject matter. The gemstone processing system, according to the present subject matter, provides for a pre-planning step in which the stresses located in a rough gemstone 104 are identified with substantial accuracy. In an example, the stresses can include stresses inside the gemstone. In said example, the gemstone processing system can identify the stresses in order to determine a strength of the rough gemstone 104. Further, the gemstone processing system can provide for planning of the processing of the gemstone. Accordingly, in the planning phase, various operations to be performed on the rough gemstone can be charted in accordance with the identified stresses. As will be understood, the rough gemstone can be the gemstone in the natural, non-processed condition.

In accordance with an implementation of the present subject matter, the gemstone processing system can include a visualization system 100 having an image capturing device 102, a gemstone stage 106 being rotatable with respect to the image capturing device 102, and one or more light sources 110, 112 to illuminate the rough gemstone 104 on the gemstone stage 106. The gemstone stage 106 can be provided with a holder (not shown) for mounting the rough gemstone 104. The gemstone stage 106 can be coupled to a shaft 108 which in turn can be coupled to an actuator (not shown) for effecting a rotational movement of the gemstone stage 106 about a central axis, say of the shaft 108 on which the gemstone stage 106 is mounted. In an example, the actuator and, therefore, the gemstone stage 106 can be controlled by a processing unit (not shown). In an example, the visualization system 100 can include two light sources—namely a first light source 112 and a second light source 110. In an example, the first light source 112 can be a back light source 112 and the second light source 110 can be a top light source 110. As the names suggest, the back light source 112 is positioned behind the gemstone stage 106 with respect to the image capturing device 102. In one case, the back light source 112 and the image capturing device 102 can be positioned as facing each other, with the gemstone stage 106 in between the two. The top light 110, on the other hand, can be positioned on and in-line with the central rotational axis of the shaft 108 of the gemstone stage 106.

During operation, radiations are persistently incident on the rough gemstone 104 from the light source 110, 112 as the gemstone stage 106 rotates rotating the rough gemstone 104 alongwith. In response to the passage of radiations through the rough gemstone 104, an optical pattern, say a rainbow pattern, is generated which is captured by the image capturing device 102 and stored in a database (not shown) associated with the visualization system 100. According to an aspect, the optical pattern is temporally captured along with the rotation of the rough gemstone 104, and stored. In other words, the optical pattern is captured along with its variation with time. Additionally, the image capturing device 102 can capture static frames of the rough gemstone 104.

In addition, in an implementation, the visualization system 100 can include a plurality of optical filters 114, 116 for filtering the radiations being exchanged during operation of the visualization system 100. For example, the visualization system 100 can include two optical filters 114, 116 positioned between the image capturing device 102, the back light source 112, and the gemstone stage 106. For instance, a first optical filter 116 can be positioned between the back light source 112 and the gemstone stage 106 and a second optical filter 114 can be positioned between the image capturing device 102 and the gemstone stage 106.

Further, the visualization system 100 can include a laser (not shown) for measuring the rough gemstone 104 and generating a graphical 3-dimensional view of the rough gemstone 104 based on the measurement by the laser and the temporal images of the pattern formed by the rough gemstone 104 captured by the image capturing device 102. In an implementation, the visualization system 100 can associate a unique ID with the 3-dimensional image and store the same in the database associated with the visualization system 100. Therefore, the laser can augment the operation of the visualization system and can facilitate in the planning phase of gemstone processing. For example, the visualization system 100 can provide the generated 3-dimensional view of the rough gemstone 104 and provide the same to a planning unit (not shown) of the gemstone processing system.

In an implementation, the planning unit can include another set of gemstone stage and an image capturing device which can temporally capture frames, say as images or video, of the gemstone. In said implementation, the planning unit can use the temporal images of the pattern formed by the rough gemstone 104, the graphical 3-dimensional view, the rough gemstone 104, and the captured static and temporal frames of the rough gemstone 104, in various combinations, for analysis. Based on the analysis, the planning unit can generate different plans for cutting the rough diamond without breakage. A user of the gemstone processing system can select one of the plans which can be physically marked on the rough gemstone 104 and the rough gemstone 104 is further processed, say cut and finished, based on the selected plan, say in a gemstone cutting and finishing system (not shown). In an example, the gemstone cutting and finishing system can be a part of the gemstone processing system.

In addition, the planning unit can provide the temporally captured images of the rough gemstone to the user which can be used in analysis to reduce breakage in later procedures. For example, based on the analysis of the temporally captured images, the user can determine the type of laser to be used for cutting the gemstone. For instance, the user may decide whether to use a high intensity laser, such as a red laser, or to use a moderate or low intensity laser, such as a green laser for cutting the gemstone, based on the analysis of the temporally captured images. This can facilitate in reducing the possibility of damage to the gemstone during processing. Further, the captured images can be used to analyze the rough gemstone 104 in case there is a breakage even after planning.

Further, the present subject matter relates to a method for gemstone processing, in accordance with an implementation of the present subject matter. As would be understood, the method steps are the same as described above with reference to the gemstone processing system.

Although implementations for methods and systems for gemstone processing are described, it is to be understood that the present subject matter is not necessarily limited to the specific features or methods described. Rather, the specific features and methods are disclosed as implementations for gemstone processing.

I/We claim:

1. A visualization system comprising:
a gemstone stage comprising a gemstone holder to hold a rough gemstone;
a first light source to illuminate the rough gemstone positioned in the gemstone holder;
an image capturing device in-line with the first light source to:
capture a temporal optical pattern generated by the rough gemstone over a predetermined period of time; and
capture at least one static frame of the rough gemstone; and
a planning unit to generate at least one cutting plan for cutting the rough gemstone, based on the temporal optical pattern of the rough gemstone and the at least one static image of the rough gemstone.

2. The visualization system as claimed in claim 1, wherein the gemstone stage is coupled to an actuator, and wherein the visualization system comprises a processing unit to control the actuator to control movement of the gemstone stage.

3. The visualization system as claimed in claim 1, further comprising a second light source in-line with a central axis longitudinal axis of the gemstone stage, wherein the second light source is in-line with the second image capturing device.

4. The visualization system as claimed in claim 1, further comprising a plurality of optical filters positioned between the gemstone stage, the first light source, and the primary image capturing device, and between the gemstone stage, the second light source, and the second image capturing device, wherein the plurality of optical filter are to filter radiations emanating from the first light source and the second light source.

5. The visualization system as claimed in claim 1, further comprising a laser for measuring and generating a graphical 3-dimensional image of the rough gemstone.

6. The visualization system as claimed in claim 5, wherein the graphical 3-dimensional image, a unique identity is associated with the gemstone.

7. The visualization system as claimed in claim 1, wherein the planning unit comprises another set of gemstone stage and an image capturing device to temporally capture frames of the rough gemstone after planning, wherein the rough gemstone is analyzed based on the temporally captured frames.

8. A method for processing a rough gemstone comprising:
illuminating the rough gemstone;
rotating the rough gemstone;
capturing an optical pattern generated by the rotating rough gemstone after illumination;
generating a graphical 3-dimensional image of the rough gemstone; and
determining at least one cutting plan for cutting the rough gemstone based on the captured optical pattern of the rough gemstone and the graphical 3-dimensional image of the rough gemstone.
